(19) United States
(12) Patent Application Publication
(10) Pub. No.: US 2011/0210074 A1
(43) Pub. Date: Sep. 1, 2011

(54) REMOVAL OF MYOGLOBIN FROM BLOOD AND/OR PHYSIOLOGICAL FLUIDS

(76) Inventors: James F. Winchester, Mclean, VA (US); Wei-Tai Young, Hillsborough, NJ (US); Vincent J. Capponi, Monmouth Junction, NJ (US)

(21) Appl. No.: 12/737,284

(22) PCT Filed: Jun. 26, 2009
(86) PCT No.: PCT/US2009/003826

§ 371 Date: May 16, 2011

Related U.S. Application Data
(60) Provisional application No. 61/075,893, filed on Jun. 26, 2008.

(51) Int. Cl. B01D 15/08

(52) U.S. Cl. 210/690

(57) ABSTRACT

A polymer sorbent clears myoglobin from blood and/or other physiological fluids and solutions. Normal saline or human serum in which myoglobin was dissolved is perfused by a peristaltic pump through a column packed with the polymer sorbent. After a four-hour perfusion, the myoglobin level in normal saline fell from initial levels to virtually undetectable levels. Perfusion through the polymer sorbent was then found to lower concentrations of dissolved myoglobin to a significant degree in samples of human serum after four hours, indicating that the polymer sorbent is an effective sorbent for myoglobin.

### BACKGROUND OF THE INVENTION

1. Field of the Invention

This invention relates to the processing of blood and/or other physiological fluids and solutions, and in particular to a polymer sorbent which significantly reduces concentrations of myoglobin in blood and/or other physiological fluids and solutions.

2. Description of the Related Art

Rhabdomyolysis can result in acute kidney injury from myoglobinuria when the myoglobin released into the blood from damaged muscle passes through the glomerular filter and becomes inspissated in the renal tubules, as described in Zager, R. A., Kidney Int. 49, 314-326 (1996). While prophylactic hemodialysis or hemofiltration with high-permeability dialysis membranes can remove substantial amounts of myoglobin from the blood, thus far even the best myoglobin clearances have failed to eliminate this protein entirely from plasma, as described in Maduell, F., Navarro, V., Cruz, M. C., Torregrosa, E., Garcia, D., Simon, V., Ferraro, J. A., Am. J. Kidney Dis. 40, 582-589 (2002); and Naka, T., Jones, D., Baldwin, I., Fealy, N., Bates, S., Goehl, H., Morgera, S., Neumeyer, H. H., Bellomo, R., Crit. Care 9, R90-R95 (2005). The use of sorbents has been suggested for the removal of large molecules from blood circulation, as described in Winchester, J. F., Ronco C., Brady, J. A., Cowgill, L. D., Salsberg, J., Yousha, E., Choquette, M., Albright, R., Clemmer, J., Davankov, V., Tsyurupa, M., Pavlova, L., Pavlov, M., Cohen, G., Horl, W., Gotch, F., Levin, N., Blood Purif. 20, 81-86 (2002).

Large amounts of myoglobin in the blood can cause renal injury by provoking constriction of renal vessels, forming obstructing casts in the lumina of renal tubules, and initiating interstitial inflammation, as described in Zager, R. A., Ren. Fail., 14, 341-344 (1992). A small case series suggests that following rhabdomyolysis, the actual concentration of myoglobin in the urine, which correlates with the blood level, may be an important factor in determining whether kidney injury will occur, as described in Feinfeld, D. A., Cheng, J. T., Beysolow, T. D., Briscoe, A. M., Clin. Nephrol., 38, 193-195 (1992). While early and vigorous intravenous infusion of isotonic fluids may help prevent myoglobinuric renal failure, as described in Ron, D., Taitelman, U., Michaelson, M., Bar-Joseph, G., Bursztein, S., Better, O. S., Arch. Intern. Med., 144, 277-280 (1984); and Dubrow, A., Flamenbaum, W., in Acute Renal Failure, ed. Brenner, B. M., Lazarus, J. M., Churchill Livingstone, New York, 1988, 2nd ed, Chap. 10, pp. 279-293, a means of clearing myoglobin from plasma rapidly might also decrease the risk of acute kidney injury.

Hemodialysis with membranes is not effective in lowering plasma myoglobin levels, as described in Hart, P. M., Feinfeld, D. A., Briscoe, A. M., Nurse, H. M., Hotchkiss, J. L., Thomson, G. E., Clin. Nephrol., 18, 141-143 (1982). Newer, high-flux membranes are much more effective in clearing circulating myoglobin from the blood, as described in Maduell, F., Navarro, V., Cruz, M. C., Torregrosa, E., Garcia, D., Simon, V., Ferraro, J. A., Am. J. Kidney Dis. 40, 582-589 (2002); and Naka, T., Jones, D., Baldwin, I., Fealy, N., Bates, S., Goehl, H., Morgera, S., Neumeyer, H. H., Bellomo, R., Crit. Care 9, R90-R95 (2005). However, some studies have found that dialysis or hemoperfusion even with the high-permeability membranes does not always cause a substantial fall in myoglobin levels, as described in Stefanovic, V., Bogicevic, M., Mitic, M., Int. J. Artif. Organs, 16, 659-661 (1993); and Shigemoto, T., Rinka, H., Matsuo, Y., Kaji, A., Tsukioka, K., Ukai, T., Shimaoka, H., Ren. Fail., 19, 711-719 (1997).

Additionally, in those cases of effective clearance of myoglobin from blood by high-flux or ultra-high-flux membranes, the final plasma myoglobin levels were not reduced below 16,000 ng/ml, which may still be high enough to affect renal function, as described in Naka, T., Jones, D., Baldwin, I., Fealy, N., Bates, S., Goehl, H., Morgera, S., Neumeyer, H. H., Bellomo, R., Crit. Care 9, R90-R95 (2005); and Amyot, S. L., Leblanc, M., Thibeault, Y., Geadah, D., Cardinal, J., Intens. Care Med., 25, 1169-1172 (1999).

In the prior art, there are no known porous polymers which can be used to remove heme-like molecules, for example, myoglobin, from blood, or specifically for the treatment of rhabdomyolysis. In addition, in the prior art, heme interaction with polymer sorbents is not predictable based on known research concerning the adsorption of aromatic amino acids and synthetic aromatic proteins containing various side groups. Studies have been conducted concerning the adsorption of various amino acids such as tyrosine (aromatic), and synthetic peptides such as phenylalanine-phenylalanine (Phe-Phe), containing 100% aromatic amino acids. Known polymers should adsorb both tyrosine and Phe-Phe based on size and the aromatic nature alone, but tyrosine (100% aromatic, molecular weight 0.18 kDa) has been found to not be adsorbed, while Phe-Phe (100% aromatic, molecular weight 0.312 kDa) was adsorbed but was about four times less than larger proteins such as albumin, containing about 9% aromatic amino acids. This lack of tyrosine adsorption and muted absorbance of Phe-Phe, in comparison to albumin, onto known polymer sorbents represents a complex relationship between size and chemical properties, that is, hydrophobicity/aromaticity. According, based on the prior art, those researchers seeking to clear myoglobin from blood and/or other physiological fluids and solutions have been unable to determine the best polymer sorbents to perform such myoglobin removal, since such researchers in the prior art have been unable to predict, a priori, what will or will not adsorb onto polymer sorbents known in the prior art.

### BRIEF SUMMARY OF THE INVENTION

A polymer sorbent as described herein clears myoglobin from blood and/or other physiological fluids and solutions. Normal saline or human serum in which myoglobin was dissolved is perfused by a peristaltic pump through a column packed with the polymer sorbent. After a four-hour perfusion, the myoglobin level in normal saline fell from initial levels to virtually undetectable levels. Perfusion through the polymer sorbent was then found to lower concentrations of dissolved myoglobin to a significant degree in samples of human serum after four hours, indicating that the polymer sorbent is an effective sorbent for myoglobin. In vitro testing of the polymer sorbent described herein, and commercially available from “CYTOSORBENTS, INC.” under the trade name “X-SORB”, was performed and found to substantially clears myoglobin effectively from the blood.

The polymer sorbent of the present invention works by size exclusion, based on molecular weight, and surface adsorption mediated through molecular interactions, such as Van der Waals forces. Van der Waals force is the attractive or repulsive force between molecules, or between parts of the same molecule, other than those due to covalent bonds or to the electrostatic interaction of ions with one another or with neutral molecules. In the case of the polymer sorbent of the present invention, the mechanism of adsorption involves hydrophobic/aromatic Van der Waal interactions. A molecule must be of the appropriate size and chemical composition, for example, by containing regions of hydrophobicity/aromaticity, to adhere or adsorb to the surface of the polymer; otherwise, the molecule passes through the polymer. As a matter of background, chemically speaking, myoglobin is a protein (7% aromaticity, molecular weight of about 17 kDa) containing a variety of aromatic and non-aromatic amino acids and a heme group that includes a heterocyclic macrocycle that is aromatic.

Adsorption of myoglobin or other heme-containing proteins, for example, hemoglobin, by the polymer sorbent of the present invention is not obvious for several reasons. First, in the prior art, there are no reported examples in the literature of porous polymers being used to remove heme-like molecules, for example, myoglobin, from blood or specifically for the treatment of rhabdomyolysis. Secondly, the heme interaction with the polymer sorbent of the present invention is not predictable based on earlier work done in the prior art concerning the adsorption of aromatic amino acids and synthetic aromatic proteins containing various side groups. Studies have been conducted concerning the adsorption of various amino acids such as tyrosine (aromatic), and synthetic peptides such as phenylalanine-phenylalanine (Phe-Phe) containing 100% aromatic amino acids. The polymer sorbent of the present invention should adsorb both tyrosine and Phe-Phe based on size and the aromatic nature alone, but tyrosine (100% aromatic, molecular weight 0.18 kDa) was not adsorbed while Phe-Phe (100% aromatic, molecular weight 0.312 kDa) was adsorbed but was about four times less than larger proteins such as albumin (containing about 9% aromatic amino acids). This lack of tyrosine adsorption and muted absorbance of Phe-Phe, in comparison to albumin, onto the polymer sorbent of the present invention represents a complex relationship between size and chemical properties, that is, hydrophobicity/aromaticity, and one cannot predict, a priori, what will or will not adsorb onto the polymer sorbent.

The polymer sorbent of the present invention has been found experimentally to significantly and substantially remove myoglobin in unexpected amounts from blood and/or other physiological fluids and solutions, and so use of the method of the present invention employing the disclosed polymer sorbent provides significant advantages over the prior art to remove myoglobin.

### BRIEF DESCRIPTION OF THE SEVERAL VIEWS OF THE DRAWINGS

Preferred embodiments of the invention are disclosed hereinbelow with reference to the drawings.

FIG. 1 is a flowchart of the method of removing myoglobin using the polymer sorbent.

FIG. 2 is a graph illustrates the mean percentage reduction in myoglobin using the disclosed polymer sorbent.

### DETAILED DESCRIPTION OF THE INVENTION

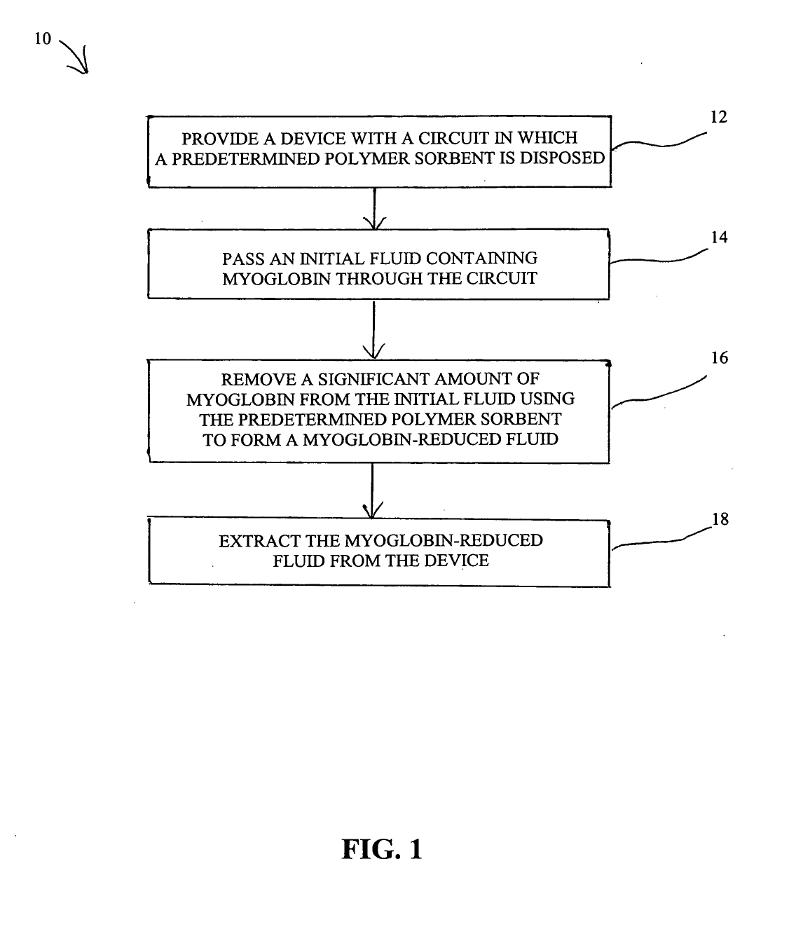

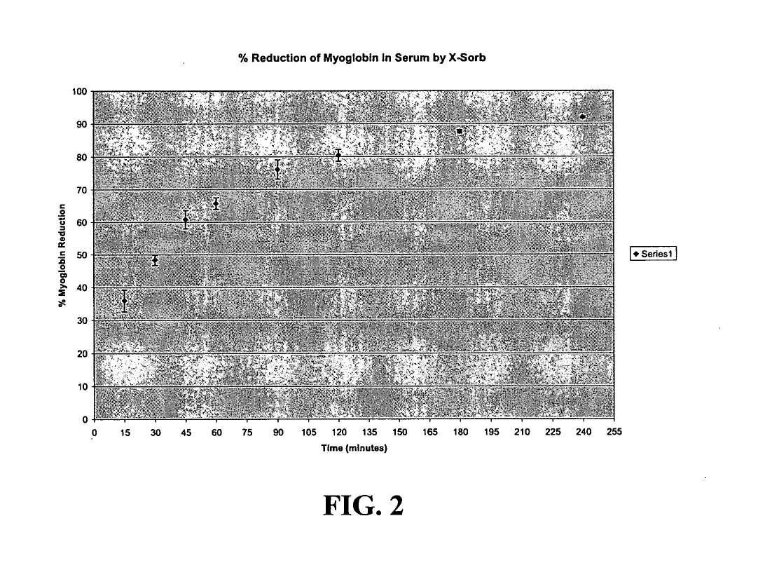

As shown in FIGS. 1-2 and as described herein, the present invention includes a method as well as devices which employ a polymer sorbent to clear myoglobin from blood and/or other physiological fluids and solutions. Normal saline or human serum in which myoglobin was dissolved is perfused by a peristaltic pump through a column packed with the polymer sorbent. After a four-hour perfusion, the myoglobin level in normal saline fell from initial levels to virtually undetectable levels. Perfusion through the polymer sorbent was then found to lower concentrations of dissolved myoglobin to a significant degree in samples of human serum after four hours, indicating that the polymer sorbent disclosed herein is an effective sorbent for myoglobin.

Using the disclosed polymer sorbent described herein, the present invention provides devices and methods of removing myoglobin from blood, desirably whole blood, or blood products, or physiologic fluids in situations where an abnormal level of myoglobin in blood exists. In the method 10 of the present invention shown in FIG. 1, myoglobin is removed from an initial fluid, with the method including the initial step 12 of providing a device with a circuit such as a column in which the predetermined polymer sorbent described herein is disposed.

The method 10 then includes the steps of passing the initial fluid containing the myoglobin through the circuit, in step 14; removing a significant amount of myoglobin from the initial fluid using the predetermined polymer sorbent to form a myoglobin-reduced fluid in step 16; and extracting the myoglobin-reduced fluid from the device in step 18.

In one embodiment, the blood of a patient is drawn and passed through an extracorporeal circuit in which a device is filled with the predetermined polymer sorbent, in the form of a hemocompatible polymeric adsorber which adsorbs myoglobin while the rest of the blood passing through and returns to the patient. The hemocompatible polymer has a bead size ranging from about 100 micrometers to about 2000 micronmeters, and with a pore volume greater than about 0.2 cc/g and a pore diameter in the range of about 1 nm to about 100 nm, which is synthesized by macroreticular synthesis in which droplets of monomer mixture are suspending in an aqueous solution in a well-mixed and temperature-controlled polymerization reactor. The monomer mixture contains polymerizable monomers, a crosslinking agent, a chain initiator, and a non-polymerizable dilutent (or porogen). The polymerization starts with the initiation of free radicals and a reaction with the monomers to start a chain formation which grows with continual insertion of the monomers. The crosslinking agent also can be inserted into the live polymer chain, and branches out to form covalent bonding between polymer chains which results in a rigid polymer structure. By controlling the amount of porogen in the droplet, the polymer chains precipitate out, forming a solid bead of desired pore structure; that is, the pore density and pore size. The dispersant present in aqueous solution provide the stability of the droplet at a proper agitation throughout the polymerization process and is important in controlling the final bead size. The dispersant is a surface active agent between the monomer mixture and aqueous solution, and also provides the hydrophilicity and hemo-compatible surface of the formed polymer beads.

The final polymer structure varies depending on the composition of the monomer mixture and the aqueous solution, the mixing condition, and the temperature of the polymerization. After polymerization, the polymer is sized for proper size fraction, cleaned to remove other non-polymerizable components, and followed by a grafting reaction to add hemocompatible molecules onto the surface of the polymer beads to enhance its hemocompatibility. The grafted polymer is then further cleaned to remove all non-polymeric organics, wetted, and packed into a device to be used in an extracorporeal circuit or column.

The polymer sorbent of the present invention is formed from a monomeric raw material which is selected from divinylbenzene, ethylvinylbenzene, styrene, and monomers including vinylaromatic compounds, derivatives of acrylic acid, and derivatives of methacrylic acid.

The biocompatibility of the polymer is derived from the surface grafting, from the dispersing agent or a secondary grafting step, selected from the group consisting of poly(hydroxyethyl methacrylate), poly(hydroxyethyl acrylate), poly(dimethylaminoethyl methacrylate), salts of poly(acrylic acid), salts of poly(methacrylic acid), poly(diethylaminoethyl methacrylate), poly(hydroxypropyl methacrylate), poly(hydroxypropyl acrylate), poly(N-vinylpyrrolidinone), poly(vinyl alcohol) and mixtures thereof.

In forming the disclosed polymer sorbent, dispersing agents are used which are selected from a group consisting of hydroxyethyl cellulose, hydroxypopyl cellulose, poly(hydroxyethyl methacrylate), poly(hydroxyethyl acrylate), poly(hydroxypropyl methacrylate), poly(hydroxypropyl acrylate), poly(dimethylaminoethyl methacrylate), poly(dimethylaminoethyl acrylate), poly(diethylaminoethyl methacrylate), poly(diethylaminoethyl acrylate), poly(vinyl alcohol), poly(N-vinylpyrrolidinone), salts of poly(methacrylic acid), and salts of poly(acrylic acid) and mixtures thereof.

The crosslinking agents used to form the disclosed polymer sorbent include copolymers of divinylbenzene, trivinylbenzene, divinylnaphthalene, trivinylcyclohexane, and divinylsulfone with co-monomers being selected from a group consisting of styrene, ethylstyrene, acrylonitrile, butyl methacrylate, octyl methacrylate, butyl acrylate, octyl acrylate, cetyl methacrylate, cetyl acrylate, ethyl methacrylate, ethyl acrylate, vinyltoluene, vinylnaphthalene, vinylbenzyl alcohol, vinylformamide and mixtures thereof.

In one embodiment, the hemoperfusion device includes elements for packing the porous polymeric adsorbent that meets the pore diameter and pore volume criteria described herein in a container through which a physiological fluid perfuses, such as blood or plasma, and the myoglobin is removed from the physiological fluid. In another embodiment, the device with the polymer sorbent of present invention is used to remove myoglobin from blood in conjunction with a hemodialyzer simultaneously in an extracorporeal circuit of a hemodialysis treatment.

For the purposes of this invention, the term “pore volume” is defined as the aggregate volume of pores in a unit weight of dry adsorbent and having a unit of cc/g. The term “surface area”, a synonym to “BET surface area”, is defined as the aggregate surface area of pores in a unit weight of dry adsorbent and has a unit of m²/g.

For purposes of this invention, the pore structure is measured based on the nitrogen adsorption-desorption isotherm run at 77° K as carried out with a conventional pore structure characterization instrument such as Micromeritics ASAP2010 or an equivalent instrument. The term “pore diameter” and “pore volume” described in this invention are derived from the desorption branch of nitrogen isotherm by BJH method, described in Analytical Methods in Fine Particle Technology, 1997, Micromeritics Inst. Corp., Norcaross, Ga., ISBN 0-9656783-0-X. The term “surface area” described in this invention is measured by Micromeritics ASAP2010.

For the purpose of this invention, the pore volume and pore diameter are chosen as the descriptors to specify the pore structure for selective adsorption. Other descriptors such as “pore surface”, “average pore diameter”, or “pore mode”, as described in Reactive Polymers, Elsevier Science Publishers B.V., Amsterdam, 1986, vol. 4, pp. 155-177, can be used to specify the pore structure but will be mutual inclusive with the dual descriptors consisting of pore volume and pore diameter.

For the purpose of this invention, the term “perfusion” is defined as passing a physiological fluid within a suitable extracorporeal circuit, through a device containing adsorbents to remove toxins from the fluid. The term “hemoperfusion” is a special case of perfusion where the physiological fluid is blood. The term “hemocompatibility” is defined as a condition whereby a material, when placed in contact with whole blood or blood components, results in clinically acceptable physiological changes. The term “dispersing agent” is defined as a substance that imparts a stabilizing effect upon a finely divided array of immiscible particles or droplets suspended in a fluidizing medium.

The detailed embodiments of the polymer sorbent of the present invention are disclosed herein, but it is to be understood that the disclosed embodiments are merely examples of the invention that may be embodied in various forms. Therefore, specific structural and functional details disclosed herein are not to be interpreted as limiting, but merely as a basis for the claims and as a representative basis for teaching one skilled in the art to make and use the present invention.

The specific examples described herein enable the invention to be better understood. However, the disclosed examples are provided merely by way of guidance and do not imply any limitation.

### Example 1

### Adsorbent Synthesis

The synthesis process in Example 1 include preparing the aqueous phase and the organic phase charges, carrying out polymerization, and purifying the resulting porous polymer absorbent. Table 1 illustrates the material charges of organic phase, aqueous phase, and initiator for a five liter polymerization. Table 2 and 3 illustrate the composition of each phase by weight percent (Wt %), with the aqueous phase composition in Table 2, and the organic phase composition in Table 3.

TABLE 1

| Polymerization Charges to 5-Liter Reactor | Wt, g |
|---|---|
| Weight of Aqueous Solution | 1773.62 |
| Weight of monomer mixture (excluding | 1533.17 |
| initiator) | |
| Initiator: 97 Wt % Benzoyl Peroxide | 8.84 |
| Total Charges | 3315.6 |

TABLE 2

| Aqueous Phase Composition | Wt % |
|---|---|
| Purified Water | 97.79 |
| Dispersing agent: Polyvinylalcohol | 0.29 |
| Monosodium Phosphate | 0.30 |
| Disodium Phosphate | 1.00 |
| Trisodium Phosphate | 0.62 |
| Sodium Nitrite | 0.003 |

TABLE 3

| | Wt % |
|---|---|
| Organic Phase Composition | |
| (excluding initiator) | |
| Divinylbenzene | 35.86 |
| Ethylvinylbenzene | 20.14 |
| Inert | 0.77 |
| Toluene | 19.23 |
| Isooctane | 24.00 |
| Initiator | |
| Benzoyl Peroxide, wt. % of monomers | 1.03 |

Upon preparation of the aqueous and organic phases, the aqueous phase is poured into the reactor. The aqueous phase is heated to 65° C. at a gentle agitation. The organic phase, pre-mixed with the initiator, is then poured into the reactor onto the aqueous phase with the agitator set at a speed for appropriate formation of droplet size. The droplet dispersion is then heated to about 75° C. plus or minus 2.0° C., and held at that temperature for ten hours.

The slurry is cooled to about 70° C., the agitator is turned off, and the polymer beads are allowed to float on the aqueous phase. The mother liquor is then removed and discarded. The beads are washed thoroughly with purified water and then cleaned.

The beads are further dispersed in a surface grafting reactor to insert N-vinylpyrrolidinone on the residual vinyl bonds to form poly N-vinylpyrrolidinone on the bead surface to afford the highly hemocompatible adsorber. The beads are further washed by water and thermal cleaned. The process results in a clean and dry porous adsorbent in the form of spherical beads.

### Example 2

### Pore Structure Characterization

The pore structure of the beads of adsorbent synthesize from Example 1 was analyzed by Micromeritics ASAP2010 and the results are illustrated in Table 4. This adsorbent has an pore distribution of 0.306 cc/g of pore volume in 5 nm to 15 nm diameter pores, 0.391 cc/g in 15 nm to 25 nm diameter pores, and 0.034 cc/g pore in pores greater than 25 nm in diameter,

TABLE 4

| Pore diameter range | Pore volume |
|---|---|
| 5 nm to 15 nm | 0.306 cc/g |
| 15 nm to 25 nm | 0.391 cc/g |
| >25 nm | 0.034 cc/g |

### Materials and Methods

All tests were performed in vitro as experiments performing hemoperfusion at a ratio of 1 ml of wet “X-SORB” polymer to 10 ml of either normal saline (0.9% NaCl, Injection USP, B Braun Melsungen, Germany), or human serum (Lampire Biological Laboratories, Inc). The circuit included a 10 ml column (Supelco, Bellefort, Pa.) packed with the wet polymer sorbent, that is, the “X-SORB” polymer, with tubing, a reservoir containing either normal saline or serum, and a magnetic stirrer, and propelled by a peristaltic pump.

### Normal Saline Solution Experiment

Myoglobin (Equine, M0630, Sigma-Aldrich) with an initial concentration of 200,000 ng/ml in 0.9% NaCl was pumped through the “X-SORB” column for one hour with flow rate about 13 ml/min, modeling a flow rate of 400 ml/min for a 300 ml device. Aliquots of 80 μl were collected at 0, 15, 30, 45 and 60 min.

The concentration of myoglobin was calculated by direct measurement of light absorbance at 410 nm (TIDAS I System, World Precision Instruments). A calibration curve was created using equine myoglobin solutions of known concentrations.

### Human Serum Experiments

Three dynamic experiments were performed over four hours, performing hemoperfusion. Human myoglobin, provided by Biodesign International, Saco, Me., was dissolved in 110 ml of human serum from three different donors, to give initial myoglobin concentrations ranging from 55,000 to 75,000 ng/ml. This solution was perfused through an “X-SORB” column identical to that used in the saline experiments, at a flow rate of 13 ml/min, again modeling a 400 ml/min flow for a 300 ml device. Serum samples of 80 μl were collected at the following time points: 0, 15, 30, 45, 60, 90, 120, 180 and 240 min. Concentration of myoglobin was estimated by Enzyme Immunoassay, provided by Life Diagnostics, Inc., West Chester, Pa., immediately after each experiment.

### Normal Saline Solution Experiments

Substantial removal of myoglobin from normal saline solution was observed, as shown in Table 5. A sixty minute perfusion through the polymer sorbent decreased myoglobin concentration in normal saline from 200,000 ng/ml to less than 780 ng/ml, which was a lower limit for direct UV detection of a myoglobin solution, providing over a 99% removal of myoglobin, with less than about 10% concentration of myoglobin remaining from the initial input saline fluid.

TABLE 5

| Time (minutes) | Myoglobin concentration (ng/ml) |
|---|---|
| 0 | 200,000 |
| 15 | 24,860 |
| 30 | 1,814 |
| 45 | Undetectable |

### Human Serum Experiments

After four hours of perfusion of serum though the column having the polymer sorbent, the level of myoglobin decreased from 55174 ng/ml, 55918 ng/ml and 72110 ng/ml down to 4343 ng/ml, 4451 ng/ml and 6110 ng/ml respectively. The myoglobin levels in all three serum samples at any given time point was remarkably similar, as shown in FIG. 2. The mean percentage reductions in myoglobin and standard deviations are given in Table 6.

TABLE 6

| Time of | % Decrease in Myoglobin Concentration |
|---|---|
| Perfusion (minutes) | (± Standard Deviation) |
| 15 | 35.9 ± 3.3 |
| 30 | 48.3 ± 1.6 |
| 45 | 60.8 ± 2.8 |
| 60 | 65.7 ± 1.8 |
| 90 | 76.1 ± 2.9 |
| 120 | 80.4 ± 1.8 |
| 180 | 87.6 ± 0.5 |
| 240 | 91.9 ± 0.3 |

### INDUSTRIAL APPLICABILITY

The polymer sorbent referred to herein, commercially available as “X-SORB”, is an effective polymer sorbent for myoglobin. Such a polymer sorbent, which could be added as a cartridge in series with high-flux dialysis or hemoperfusion, is useful to lower plasma myoglobin below the critical point and prevent the complications of acute rhabdomyolysis. In addition, the method of removal of myoglobin using such a polymer sorbent is useful to lower plasma myoglobin below the critical point and prevent the complications of acute rhabdomyolysis.

What is claimed is:

1. A method for removal of human myoglobin from human serum using an “X-SORB” polymer sorbent.

2. A method for removal of myoglobin from an initial fluid, the method comprising the steps of:
providing a device with a circuit in which a predetermined polymer sorbent is disposed;
passing the initial fluid containing the myoglobin through the circuit, thereby removing a significant amount of myoglobin from the initial fluid using the predetermined polymer sorbent to form a myoglobin-reduced fluid; and
extracting the myoglobin-reduced fluid from the device.

3. The method of claim 2, wherein the fluid is selected from the group consisting of blood, blood products, physiologic fluids, and solutions containing myoglobin.

4. The method of claim 2, wherein the myoglobin-reduced fluid has less than about 1% of a concentration of myoglobin than the initial fluid.

5. The method of claim 2, wherein the step of passing the initial fluid containing the myoglobin through the circuit is performed for over about four hours.

6. The method of claim 2, wherein the predetermined polymer sorbent is hemocompatible polymer having a bead size ranged from about 100 micrometers to about 2000 micronmeters and with a pore volume greater than about 0.2 cc/g and pore diameter in the range of about 1 nm to about 100 nm, which is synthesized by macroreticular synthesis in which droplets of monomer mixture are suspending in an aqueous solution in a well-mixed and temperature-controlled polymerization reactor, with the monomer mixture including polymerizable monomers, a crosslinking agent, a chain initiator, and a non-polymerizable dilutent or porogen;
wherein the polymerization of the droplets of monomer mixture starts with the initiation of free radicals and reaction with the monomers to start a chain formation which grow with continual insertion of the monomers;
wherein the crosslinking agent is inserted into the live polymer chain and branches out to form covalent bonding between polymer chains, which results in a rigid polymer structure;
wherein the polymer chains are precipitated out by controlling the amount of porogen in the droplet, thereby forming a solid bead of a predetermined pore structure, having a predetermined pore density and a predetermined pore size;
wherein a dispersant is present in the aqueous solution to provide stability of the droplet at a proper agitation throughout the polymerization process for controlling the final bead size;
wherein the dispersant is a surface active agent between the monomer mixture and aqueous solution to provide the hydrophilicity and hemo-compatible surface of the formed polymer beads;
wherein after polymerization, the polymer sorbent is sized to a predetermined size fraction, cleaned to remove other non-polymerizable components, and followed by a grafting reaction to add hemocompatible molecules onto the surface of the polymer beads to enhance the hemocompatibility of the polymer sorbent;
wherein the grafted polymer sorbent is then further cleaned to remove all non-polymeric organics, wetted, and packed into the device to be used in the extracorporeal circuit;
wherein the predetermined polymer sorbent is formed from a monomeric raw material which is selected from divinylbenzene, ethylvinylbenzene, styrene, and monomers including vinylaromatic compounds, derivatives of acrylic acid, and derivatives of methacrylic acid;
wherein the biocompatibility of the polymer is derived from the surface grafting from the dispersing agent or secondary grafting step, and selected from the group consisting of poly(hydroxyethyl methacrylate), poly(hydroxyethyl acrylate), poly(dimethylaminoethyl methacrylate), salts of poly(acrylic acid), salts of poly(methacrylic acid), poly(diethylaminoethyl methacrylate), poly(hydroxypropyl methacrylate), poly(hydroxypropyl acrylate), poly(N-vinylpyrrolidinone), poly(vinyl alcohol) and mixtures thereof;
wherein the dispersing agents are selected from a group consisting of hydroxyethyl cellulose, hydroxypopyl cellulose, poly(hydroxyethyl methacrylate), poly(hydroxyethyl acrylate), poly(hydroxypropyl methacrylate), poly(hydroxypropyl acrylate), poly(dimethylaminoethyl methacrylate), poly(dimethylaminoethyl acrylate), poly(diethylaminoethyl methacrylate), poly(diethylaminoethyl acrylate), poly(vinyl alcohol), poly(N-vinylpyrrolidinone), salts of poly(methacrylic acid), and salts of poly(acrylic acid) and mixtures thereof; and
wherein the crosslinking agent used to form the polymer sorbent include copolymers of divinylbenzene, trivinylbenzene, divinylnaphthalene, trivinylcyclohexane, and divinylsulfone with co-monomers being selected from a group consisting of styrene, ethylstyrene, acrylonitrile, butyl methacrylate, octyl methacrylate, butyl acrylate, octyl acrylate, cetyl methacrylate, cetyl acrylate, ethyl methacrylate, ethyl acrylate, vinyltoluene, vinylnaphthalene, vinylbenzyl alcohol, vinylformamide and mixtures thereof.
